(19) United States
(12) Patent Application Publication
(10) Pub. No.: US 2012/0173848 A1
(43) Pub. Date: Jul. 5, 2012

(54) PIPELINE FLUSH FOR PROCESSOR THAT MAY EXECUTE INSTRUCTIONS OUT OF ORDER

(75) Inventors: Hong Xia SUN, Beijing (CN); Yong Qiang WU, Beijing (CN); Kai Feng WANG, Beijing (CN); Peng Fei ZHU, Beijing (CN)

(73) Assignee: STMICROELECTRONICS R&D (BEIJING) CO. LTD, Beijing (CN)

(21) Appl. No.: 13/340,679

(22) Filed: Dec. 30, 2011

(30) Foreign Application Priority Data
Dec. 30, 2010 (CN) 201010624755.0

(51) Int. Cl. G06F 9/38; G06F 9/30

(52) U.S. Cl. 712/205; 712/234; 712/208; 712/E09.016; 712/E09.062

(57) ABSTRACT

An embodiment of an instruction pipeline includes first and second sections. The first section is operable to provide first and second ordered instructions, and the second section is operable, in response to the second instruction, to read first data from a data-storage location, is operable, in response to the first instruction, to write second data to the data-storage location after reading the first data, and is operable, in response to the writing the second data after reading the first data, to cause the flushing of a some, but not all, of the pipeline. Such an instruction pipeline may reduce the processing time lost and the energy expended due to a pipeline flush by flushing only a portion of the pipeline instead of flushing the entire pipeline.

### PRIORITY CLAIM

The instant application claims priority to Chinese Patent Application No. 201010624755.0, filed Dec. 30, 2010, which application is incorporated herein by reference in its entirety.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

An embodiment of an instruction pipeline includes first and second sections. The first section is operable to provide first and second ordered instructions, and the second section is operable, in response to the second instruction, to read first data from a data-storage location, is operable, in response to the first instruction, to write second data to the data-storage location after reading the first data, and is operable, in response to writing the second data after reading the first data, to cause the flushing of some, but not all, of the pipeline.

In an embodiment, such an instruction pipeline may reduce the processing time lost and the energy expended due to a pipeline flush by flushing only a portion of the pipeline instead of flushing the entire pipeline. For example, a superscalar processor may perform such a partial pipeline flush in response to a mis-speculative load instruction, which is, a load instruction that is executed relative to a memory location before the execution of a store instruction relative to the same memory location, where the store instruction comes before the load instruction in the instruction order. The processor may perform such a partial pipeline flush by reloading the instruction-issue queue from the reorder buffer such that a fetch-decode section of the pipeline need not be and, therefore, is not, flushed.

### BRIEF DESCRIPTION OF THE DRAWINGS

FIG. 1 is a block diagram of an embodiment of superscalar processor having an instruction pipeline.

FIG. 2 is block diagram of an embodiment of the instruction pipeline of FIG. 1 with an embodiment of a store-load pipeline branch shown in detail.

FIG. 3 is a flow chart of an in-order execution of store and load instructions relative to a same memory location.

FIG. 4 is a flow chart of an out-order execution of store and load instructions relative to a same memory location.

FIG. 5 is a block diagram of an embodiment of the instruction pipeline of FIG. 2 during an operating state during which, or before which, a load instruction relative to a memory location is executed.

FIG. 6 is a block diagram of an embodiment of the instruction pipeline of FIG. 2 during an operating state subsequent to the operating state of FIG. 5 and during which a store instruction relative to the same memory location is issued.

FIG. 7 is a block diagram of an embodiment of the instruction pipeline of FIG. 2 during an operating state subsequent to the operating state of FIG. 6 and during which the previously executed load instruction is flagged as having been mis-speculative.

FIG. 8 is a block diagram of an embodiment of the instruction pipeline of FIG. 2 during an operating state subsequent to the operating state of FIG. 7 and during which some, but not all, of the pipeline is flushed.

FIG. 9 is a block diagram of an embodiment of the instruction pipeline of FIG. 2 during an operating state subsequent to the operating state of FIG. 8 during which the instruction-issue queue is repopulated with instructions stored in the reorder buffer.

FIG. 10 is a block diagram of an embodiment of the instruction pipeline of FIG. 2 during an operating state subsequent to the operating state of FIG. 9 during which the operation of the instruction pipeline returns to normal.

FIG. 11 is a block diagram of an embodiment of a computer system that includes an embodiment of a superscalar processor having an embodiment of the instruction pipeline of FIG. 2.

### DETAILED DESCRIPTION

A superscalar processor may include an instruction pipeline that is operable to simultaneously execute multiple (e.g., four) program instructions out of order, i.e., in an order other than the sequence in which the instructions are ordered in a program. By simultaneously executing multiple instructions out of order, a superscalar processor may be able to execute a software or firmware program faster than a processor that is operable to execute instructions only in order or only one at a time.

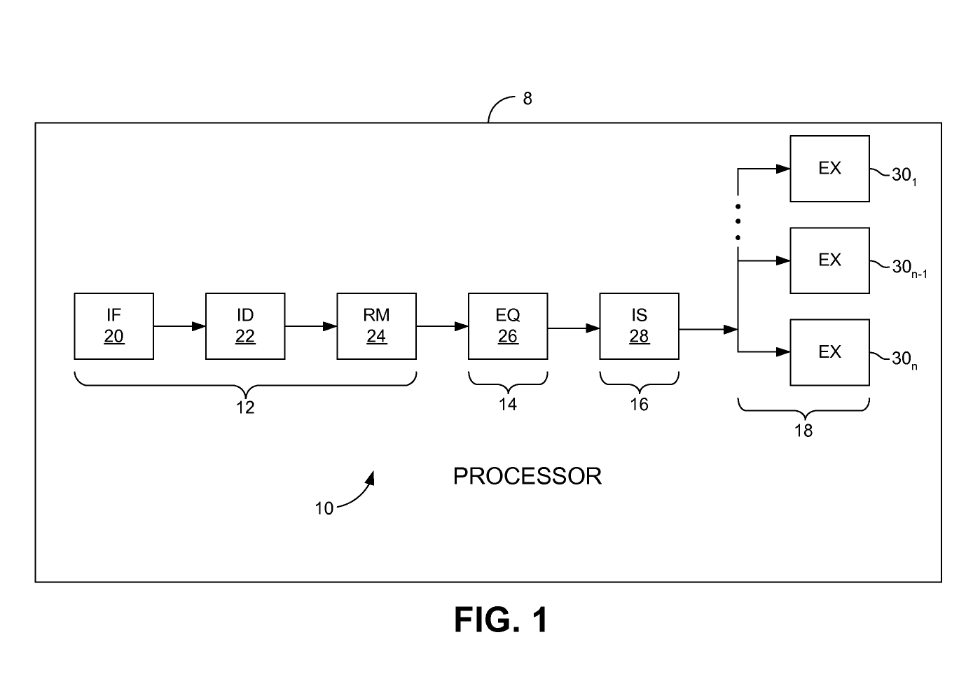

FIG. 1 is a block diagram of an embodiment of a superscalar processor 8 having an instruction pipeline 10. As discussed below, as compared to a conventional instruction pipeline, the instruction pipeline 10 may reduce pipeline-flush delays and energy consumption by flushing only part of the pipeline in response to a flush-inducing event.

The instruction pipeline 10 includes an instruction-fetch-decode section 12, an instruction-queue section 14, an instruction-issue section 16, and an instruction-execute section 18.

The instruction-fetch-decode section 12 includes an instruction-fetch (IF) stage 20, an instruction-decode (ID) stage 22, and a register-mapping (RM) stage 24.

The IF stage 20 fetches program instructions from a program memory (not shown in FIG. 1) in the program order, which may be the order in which the instructions are stored in memory—an exception may occur when a branch instruction is executed—and provides these instructions to the ID stage 22 in the order in which the instructions are fetched. For example, a program counter (not shown in FIG. 1) stores an address of the program memory, and increments (or decrements) the address during each clock cycle so that the IF stage 20 fetches program instructions from sequential addresses. A taken branch may cause the program counter to be loaded with a non-sequential address; but once reloaded, the program counter again increments (or decrements) the address during each clock cycle such that the IF stages 20 again fetches instructions from sequential addresses, i.e., in the program order, until the next taken branch.

The ID stage 22 decodes the fetched instructions in the order received from the IF stage 20.

The RM stage 24 prevents potential physical-register conflicts by remapping the processor's physical register(s) (not shown in FIG. 1) called for by an instruction if a nearby (e.g., within ten instructions) previous instruction calls for at least one of the same physical register(s). For example, suppose an add instruction calls for physical register R0, and a subtract instruction that is five instructions previous to the add instruction in the program order also calls for R0. If these instructions were guaranteed to be executed in the program order, then no register conflict would occur. But because the superscalar processor 8 may execute these instructions out of order, and may even execute these instructions simultaneously, the RM stage 22 remaps the add instruction to another physical register Rn (e.g., R23) that is not called for by any of the other nearby previous instructions.

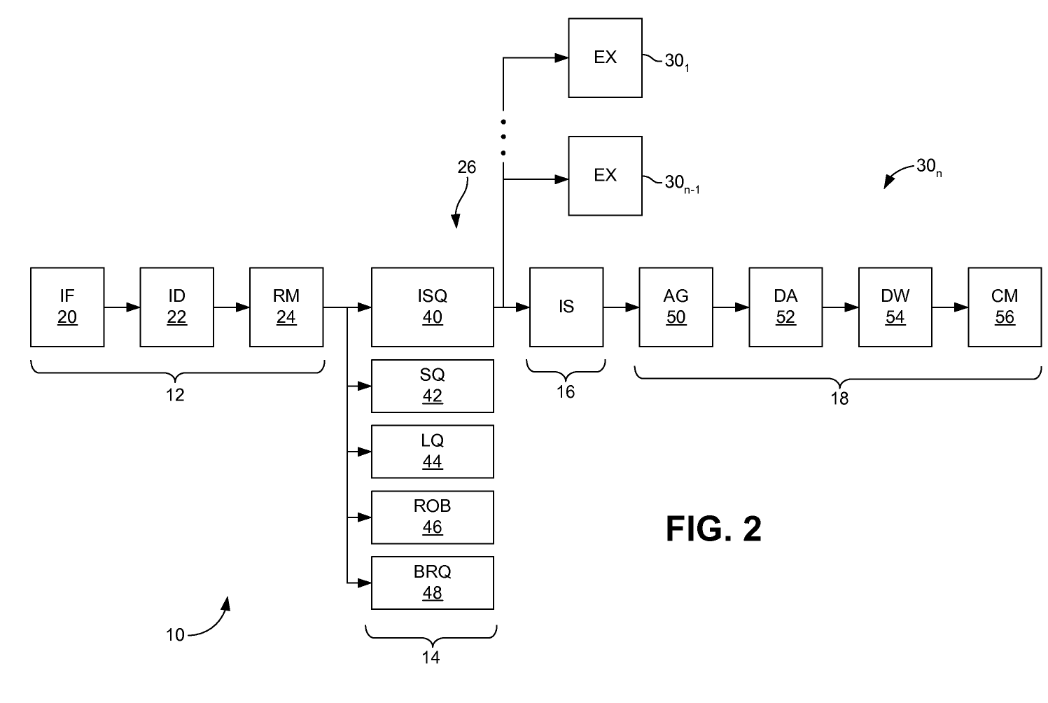

The instruction-queue section 14 includes an instruction enter-queue (EQ) stage 26, which includes one or more instruction queues that are further discussed below in conjunction with FIG. 2.

The instruction-issue section 16 includes an instruction-issue (IS) stage 28, which issues instructions from the EQ stage 26 to the instruction-execute section 18. The IS stage 28 may issue multiple instructions simultaneously, and may issue an instruction out of the program order if the instruction is ready to be executed before a previous instruction in the program order. For example, an add instruction may sum together two values that are presently available, but a previous subtract instruction may subtract one value from another value that is not yet available. Therefore, to speed up the instruction execution, instead of waiting for the other subtraction value to become available before issuing any subsequent instructions the IS stage 28 may issue the add instruction to the instruction-execute section 18 before issuing the subtract instruction to the instruction-execute section even though the subtract instruction comes before the add instruction in the program order.

The instruction-execute section 18 includes one or more instruction-execution branches 30₁-30ₙ, which are each operable to execute a respective instruction in parallel with the other branches, and to retire instructions in parallel. For example, if the pipeline 10 is operable to simultaneously execute four instructions, then the pipeline may include four or more instruction-execution branches 30. Furthermore, each branch 30 may be dedicated to a particular type of instruction. For example, a branch 30, may be dedicated to executing instructions that call for mathematical operations (e.g., add, subtract, multiply, divide) to be performed on data, and another branch 30 may be dedicated to executing instructions (e.g., data load, data store) that call for access to cache or to other memory. Furthermore, each branch 30 may retire an executed instruction after all of the instructions that come before the executed instruction in the program order are also retired or ready to be retired. As part of retiring an instruction, a branch 30 removes the instruction from all of the queues in the EQ stage 26.

Still referring to FIG. 1, an operating mode of the pipeline 10 is described.

During a first cycle of the pipeline 10, the IF stage 20 fetches one or more instructions from a program-instruction memory (not shown in FIG. 1) in the program order.

During a next cycle of the pipeline 10 cycle, the ID stage 22 decodes the one or more instructions received from the IF stage 20.

During a next cycle of the pipeline 10 cycle, the RM stage 24 remaps the physical registers of the one or more decoded instructions received from the ID stage 22 as is appropriate.

During a next cycle of the pipeline 10, the EQ stage 26 receives and stores, in one or more queues, the one or more remapped instructions from the RM stage 24.

During a next cycle of the pipeline 10, the IS stage 28 issues one or more instructions from the EQ stage 26 to one or more respective instruction-execution branches 30.

During a next cycle of the pipeline 10, each instruction-execution branch 30 that receives a respective instruction from the IS stage 28 executes that instruction.

Then, during a subsequent cycle of the pipeline 10, each of the branches 30 that executed a respective instruction retires that instruction.

The above-described sequence generally repeats until the processor 8, e.g., stops running the program, takes a branch, or encounters a pipeline-flush condition.

FIG. 2 is a block diagram of an embodiment of the instruction pipeline 10 of FIG. 1, where the block diagram includes an embodiment of the EQ stage 26 and an embodiment of a load/store-execution section 30ₙ.

The EQ stage 26 includes the following five queues/buffers that may have any suitable lengths: an instruction-issue queue (ISQ) 40, a store-instruction queue (SQ) 42, a load-instruction queue (LQ) 44, a reorder buffer (ROB) 46, and a branch-instruction queue (BRQ) 48.

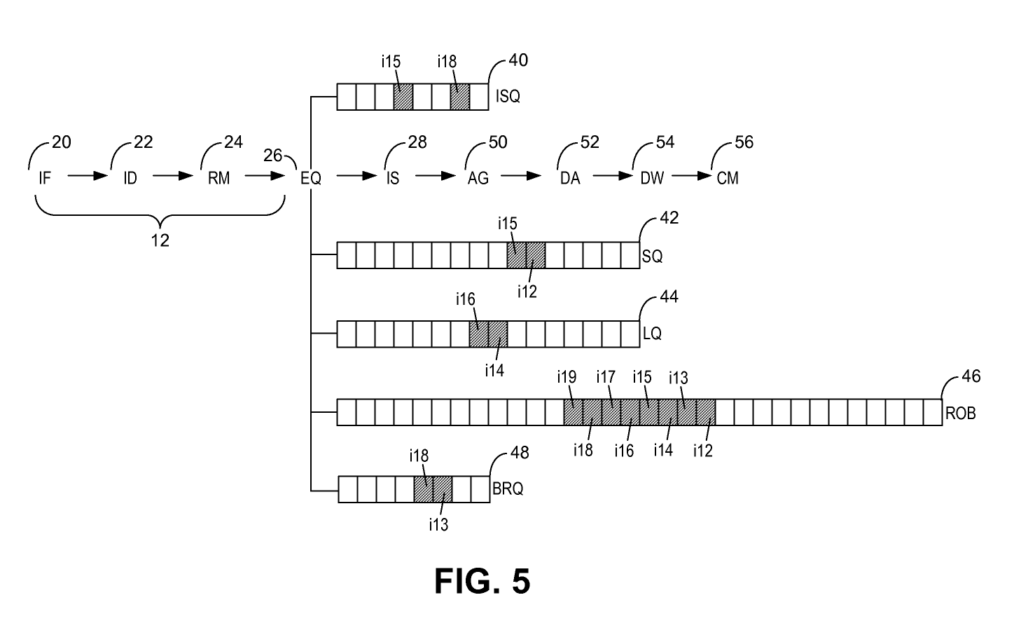

The ISQ 40 receives all of the instructions provided by the RM stage 24, and stores these instructions until they are issued by the IS stage 28 to one of the execution sections 30. As discussed above in conjunction with FIG. 1, the IS stage 28 may issue instructions out of order. Therefore, the instructions in the ISQ 40 may not be in the program order, because the instructions from the RM stage 24 enter whatever “slots” are empty in the ISQ, and these empty slots may be non-sequential. The operation of an embodiment of the ISQ 40 is further discussed below in conjunction with FIGS. 5-10.

The SQ 42 receives from the RM stage 24 only store instructions—a store instruction is an instruction that writes data to a memory location, such as a cache location—but holds these store instructions in the program order. The SQ 42 holds a store instruction until the store instruction is both executed and retired by the load/store execution section 30ₙ. The operation of an embodiment of the SQ 42 is further discussed below in conjunction with FIGS. 5-10.

The LQ 44 receives from the RM stage 24 only load instructions—a load instruction is an instruction that reads data from a memory location, such as a cache location, and then writes this data to another memory location, such as a physical register R of the processor 8—and stores these load instructions in the program order. The LQ 44 stores a load instruction until the load instruction is both executed and retired by the load/store execution section 30ₙ. The operation of an embodiment of the LQ 40 is further discussed below in conjunction with FIGS. 5-10.

The ROB 46 receives from the RM stage 24 all instructions, and stores these instructions in the program order. The ROB 46 stores an instruction until the instruction is both executed and retired by one of the execution sections 30. The operation of an embodiment of the ROB 46 is further discussed below in conjunction with FIGS. 5-10.

The BRQ 48 receives from the RM stage 24 only branch instructions—a branch instruction is an instruction that causes the program counter (not shown in FIG. 2) of the IF stage 20 to “jump” to a non-sequential address in the program memory, e.g., in response to a condition specified by the branch instruction being met—and stores these branch instructions in the program order. The BRQ 48 stores a branch instruction until the branch instruction is both executed and retired by one of the execution sections 30. The operation of an embodiment of the BRQ 48 is further discussed below in conjunction with FIGS. 5-10.

The load/store execution section 30ₙ includes an operand-address-generator (AG) stage 50, a data-access (DA) stage 52, a data-write-back (DW) stage 54, and an instruction-retire/commit (CM) stage 56. The load/store execution stage 30ₙ executes only instructions that read data from or write data to a memory location. Therefore, in an embodiment, the load/store execution stage 30ₙ executes only load and store instructions of the type that are stored in the LQ 44 and SQ 42, respectively.

The AG stage 50 receives a load or store instruction from the IS stage 28, and generates the physical address or addresses of the memory location or locations specified in the instruction. For example, a store instruction may specify writing data to a memory location, but the instruction may include only a relative address for the memory location. The AG stage 50 converts this relative address into an actual address, for example, to the actual address of a cache location. And if the data to be written is obtained from another memory location specified in the instruction, then the AG stage 50 also generates the actual address for this other memory location in a similar manner. The AG stage 50 may use a memory-mapping look-up table (not shown in FIG. 2) or other conventional technique to generate the physical address from the address included in the load or store instruction.

The DA stage 52 accesses the destination memory location specified by a store instruction (using the actual address generated by the AG stage 50), and accesses the source memory location specified by a load instruction (also using the actual address generated by the AG stage). In a first example, suppose a store instruction specifies writing data D1 from a physical register R1 to a cache location C1 (D1, R1, and C1 not shown in FIG. 2). The DA stage 52 is the stage that performs this operation; that is, the DA stage, in response to this store instruction, writes the data D1 from the physical register R1 to the cache location C1. Alternatively, the data D1 itself may be included in the store instruction, in which case the DA stage 52 writes the data included in the store instruction to the cache location C1. In a second example, suppose a load instruction specifies reading data D2 from a cache location C2 and then writing back this data to a memory location M1 (D2, C2, M1 not shown in FIG. 2). The DA stage 52 is the stage that performs the first half of this operation; that is, the DA stage, in response to this load instruction, reads the data D2 from the cache location C2—the DA stage may temporarily store D2 in a physical or other register until the DW stage 54 writes D2 to the memory location M1 as described below.

The DW stage 54 effectively ignores a store instruction, and performs the second operation (e.g., the “write-back” portion) of a load instruction. For example, although the DW stage 54 may receive a store instruction from the DA stage 52, it performs no operation relative to the store instruction except to provide the store instruction to the CM stage 56. For a load instruction, continuing the second example from the preceding paragraph, the DW stage 54 writes the data D2 from its temporary storage location to its destination, which is the memory location M1.

The CM stage 56 monitors the other execution sections 30₁-30ₙ₋₁, and retires a load or store instruction only when all of the instructions preceding the load or store instruction in the program order have been executed and retired. For example, suppose a load instruction is fifteenth in the program order. The CM stage 56 retires the load instruction only after the first through fourteenth instructions in the program have been executed and retired. Furthermore, as part of retiring an instruction, the CM stage 56 removes the instruction from all of queues/buffers in the EQ stage 26 where the instruction was stored. The CM stage 56 may perform such removal by actually erasing the instruction from a queue/buffer, or by moving a header or tad pointer associated with the queue/buffer such that the instruction is in a portion of the queue/buffer where it will be overwritten by a subsequently received instruction.

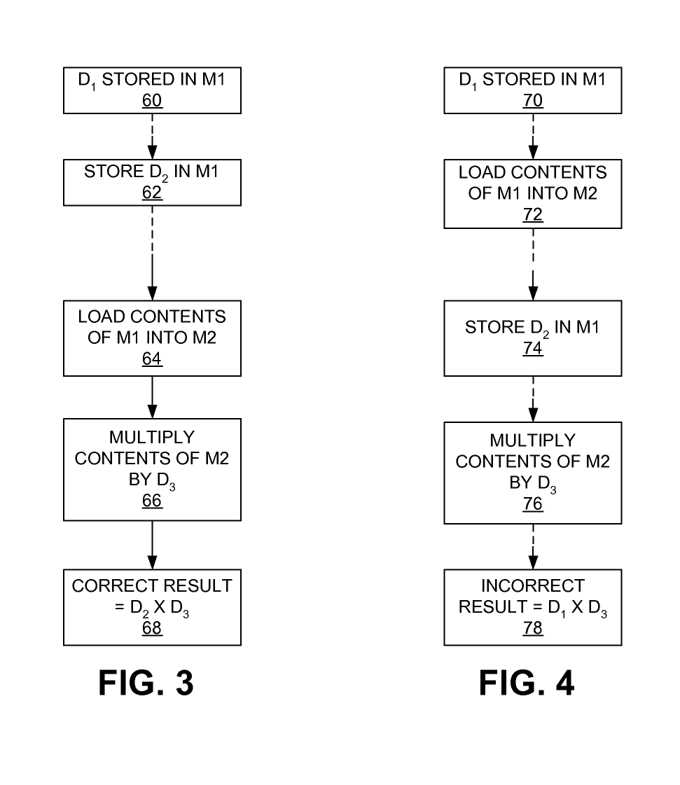

FIG. 3 is a flow diagram of a sequence of store and load instructions relative to a same memory location and executed in program order.

FIG. 4 is a flow diagram of a sequence of store and load instructions relative to a same memory location and executed out of program order.

Referring to FIGS. 2 and 3, operation of an embodiment of the pipeline 10 of FIG. 2 is discussed where a store instruction and a load instruction relative to the same memory location are executed in program order.

Referring to block 60 of FIG. 3, in an initial-state, a data value D1 is stored in a memory location at an actual address M1.

Referring to block 62, the DA stage 52 stores (writes) a data value D2 into the memory location at M1.

Referring to block 64, the DA and DW stages 52 and 54 cooperate to load the contents (the data value D2 in this example) of the memory location at M1 into another memory location at an actual address M2. That is, the DA stage 52 reads D2 from the memory location at M1, and the DW stage 54 writes D2 into the memory location at M2. Therefore, after the load operation of block 64 is executed, the data value D2 is stored in the memory location at M2.

Referring to block 66, one of the execution sections 30₁-30ₙ₋₁ multiplies the contents (the data value D2 in this example) of the memory location at M2 by a data value D3. Therefore, the multiply operation of the block 66 generates a correct result, D2×D3, as shown in block 68.

Referring to FIGS. 2 and 4, operation of an embodiment of the pipeline 10 of FIG. 2 is discussed where a store instruction and a load instruction relative to the same memory location are executed out of the program order.

Referring to block 70 of FIG. 4, in an initial state, a data value D1 is stored in the memory location at M1; this is the same initial condition as in the block 60 of FIG. 3.

Referring to block 72, because the pipeline 10 executes the store and load instructions out of order, the DA and DW stages 52 and 54 cooperate to load the contents (the data value D1 in this example) of the memory location at M1 into the memory location at M2.

Referring to block 74, the DA stage 52 writes the data value D2 into the memory location at M2. But because this store instruction is executed after the load instruction, the DA and DW stages 52 and 54 do not load D2 into the memory location at M1 as indicated by the program.

Referring to block 76, one of the execution sections 30₁-30ₙ₋₁ multiplies the contents (the data value D1 in this example) of the memory location at M2 by a data value D3. Therefore, in this example, the multiply operation of the block 76 generates an incorrect result, D1×D3, as shown in block 78, instead of generating the correct result of D2×D3 per the block 68 of FIG. 3.

Therefore, by executing load and store instructions out of program order, the pipeline 10 may generate an erroneous result.

Still referring to FIGS. 2 and 4, one technique that the processor 8 may use to prevent the erroneous result of block 78 is to implement a “look back” to the store instruction to determine whether the memory address specified by the store instruction has been resolved, and thus is available, at the time that the DA stage 52 executes the load instruction. If the memory address specified by the store instruction is available and is the same as the source memory address specified by the load instruction, then the DA stage 52 may load the data specified by the store instruction. Consequently, even if the load instruction is executed after the store instruction, the load instruction still load the correct data.

In more detail, when the DA stage 52 executes a load instruction, it may “look back” at the SQ 42 and ISQ 40 to determine whether there are any unexecuted store instructions that come before the load instruction in the program order, and may look back to the AG stage 50 to determine whether there is a store instruction being executed concurrently with the load instruction. For example, referring to FIG. 4, the DA stage 52 in block 72 determines that there is an unexecuted store instruction (the store instruction that will be executed in block 74) that comes before the load instruction in the program order.

If such a store instruction exists, then the DA stage 52 determines whether the actual memory address corresponding to the memory address specified by the store instruction has already been resolved, and, thus, is available. For example, the AG stage 50 may have resolved the actual memory address specified by the store instruction in conjunction with executing a prior load or store instruction involving the same memory address. For example, continuing the example from the preceding paragraph with reference to FIG. 4, the DA stage 52 determines whether the actual memory address for the memory location M1 is already known.

If the actual memory address corresponding to the store instruction is available, then the DA stage 52 next determines whether this actual memory address is the same as the actual memory address corresponding to the load instruction. For example, continuing the example from the preceding paragraph, the DA stage 52 determines that the actual address M1 is specified by both the load and store instructions.

If the actual memory address corresponding to the store instruction is the same as the actual memory address corresponding to the load instruction, then the DA stage 52 may, in response to the load instruction, not read the data from the actual memory address, but instead read the data directly from the store instruction. For example, continuing the example from the preceding paragraph, instead of reading the incorrect data D1 from the location at M1 in response to the load instruction, the DA stage 52 reads the data D2 from the store instruction (or from the memory location where D2 is currently stored, this memory location being specified by the store instruction). Consequently, the pipeline 10 still generates the correct result of D2×D3 per block 68 of FIG. 3.

Unfortunately, this technique may work only when the actual memory address corresponding to the store instruction is available to the DA stage 52 while the DA stage is executing a load instruction corresponding to the same address.

But if the actual memory address corresponding to the store instruction is unavailable (e.g., the actual address M1 corresponding to the store instruction is unavailable to the DA stage 52 at the time it is executing the load instruction corresponding to M1), then the processor may flush the entire pipeline 10 in response to the pipeline “realizing” that it has executed a store instruction relative to a memory location after it has executed a load instruction relative to the same memory location, where the load instruction comes after the store instruction in the program order. For example, when the DA stage 52 detects, in block 74, that it has executed the store instruction after it and the DW stage 54 have executed the load instruction in block 72, and detects that the actual address corresponding to the store instruction was not available at the time that the load instruction was executed in block 72, it may signal the processor 8 to flush the entire pipeline 10, to reload the program counter (not shown in FIGS. 2 and 4) with the address of the load instruction, and to restart operation of the pipeline from this processing point.

But flushing the entire pipeline 10 may increase the processing time required to execute the program, and may also increase the amount of energy that the processor consumes—the latter may be particularly undesirable in battery-powered devices.

Referring to FIGS. 5-10, however, in an embodiment of a technique that the processor 8 may use to prevent an erroneous result when a load from a memory location is performed out of program order relative to a store to the same memory location, the processor flushes only a portion of the pipeline 10, and repopulates the flushed portion of the pipeline from the ROB 46. Such an embodiment may reduce the processing time consumed by the flush, and may thus reduce the processing time required to execute a program in the event of a flush. Furthermore, such an embodiment may reduce the energy expended by the processer 8 in response to the flush.

FIGS. 5-10 are block diagrams of an embodiment of the pipeline 10 of FIG. 2 in various operational states before, during, and after a flush of the pipeline caused by a load instruction executed out of program order relative to a store instruction to the same memory address. In FIGS. 5-10, instructions are referred to with labels In, where n indicates the location of the instruction within the program order. Furthermore, an instruction I15 is a store instruction to a memory location at an actual memory address M1 (not shown in FIGS. 5-10), and an instruction I16 is a load instruction from the memory location at the actual address M1. The memory location at the address M1 may be a cache location or any other memory location that may be accessed by store and load instructions.

Referring to FIG. 5, prior to the operating state of the pipeline 10 represented in FIG. 5, the RM stage 24 provided instructions I1-I19 to the EQ stage 26. Furthermore, one or more of the execution sections 30₁-30ₙ (only section 30n shown in FIG. 5) has retired the instructions I1-I11 (as evidenced by the absence of these instructions from the ROB 46), the IS stage 28 has issued the unretired instructions I12, I14, I16-I17, and I19 (these instructions are unretired as evidenced by their absence from the ISQ 40 and by their respective presence in the SQ 42, LQ 44, and ROB 46), and the IS stage has not yet issued the instructions I13, I15, and I18 (as evidenced by the presence of these instructions in the ISQ).

Next, during the operating state of the pipeline 10 represented in FIG. 5, the DA stage 52 executes the load instruction I16, determines that the store instruction I15 has not yet been executed, and determines that the actual address (the actual address M1 in this example) corresponding to I15 is not yet available. Because the actual address M1 corresponding to I15 is unavailable, the DA stage 52 does not recognize that the load instruction I16 and store instruction I15 access the same memory location at M1; consequently, the DA stage executes the load instruction I16 by reading the contents of the location at M1. That is, the pipeline 10 executes the load instruction I16 out of order relative to the store instruction I15; if left unchecked, this out-of-order execution may cause an erroneous calculation result as discussed above in conjunction with FIGS. 2 and 4. Also during this operating state, the IS stage 28 issues the branch instruction I13 to one of the execution sections 30₁-30ₙ₋₁.

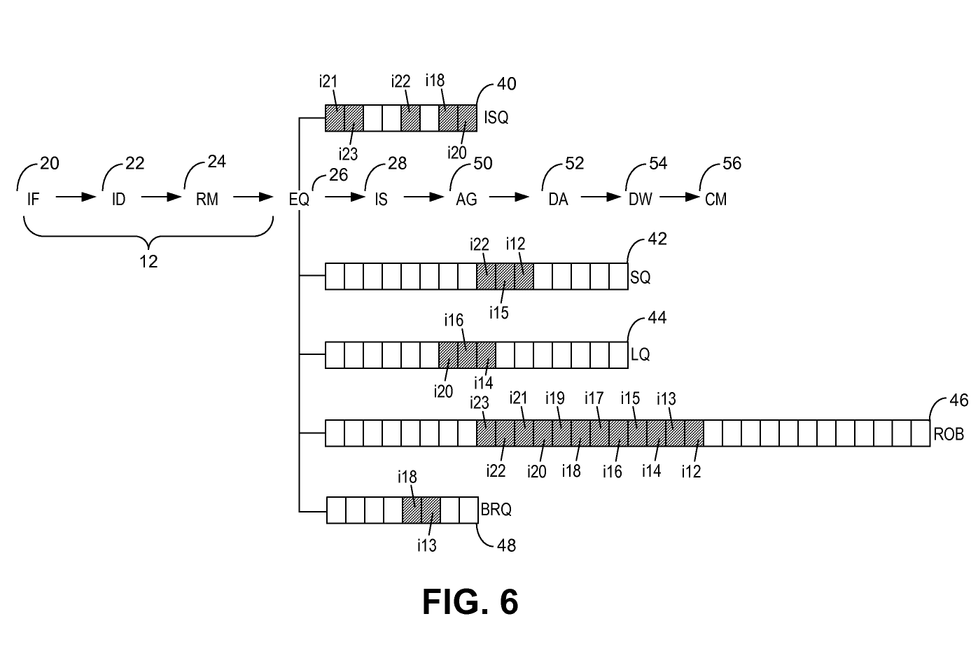

Referring to FIG. 6, in a next operating state a cycle after the operating state represented in FIG. 5, the DW stage 54 executes the write-back portion of the load instruction I16 by loading the contents that the DA stage 52 read from the source memory location at the address M1 into a destination memory location (e.g., a memory location at an actual address M2) specified by I16. Further in this operating state, the RM stage 24 provides four additional instructions I20-I23 to the ISQ 40 and the ROB 46. Because I20 is a load instruction and I22 is a store instruction, the RM stage 24 also provides I20 and I22 to the LQ 44 and SQ 42, respectively. Moreover, the IS stage 28 issues the store instruction I15 to the AG stage 50, and one of the execution sections 30₁-30ₙ₋₁ (FIG. 2) executes the branch instruction I13 (it is assumed that in this example, the branch indicated by the instruction I13 is not taken).

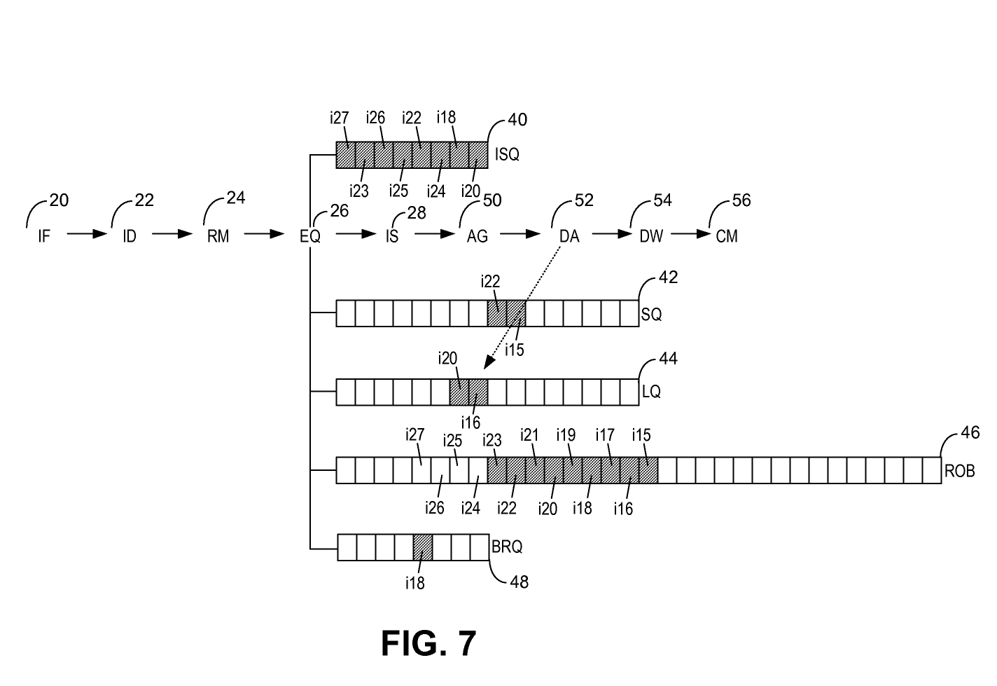

Referring to FIG. 7, in a next operating state a cycle after the operating state represented in FIG. 6, the RM stage 24 provides four instructions I24-I27 to the ISQ 40 and ROB 46, and the IS stage 28 issues the instruction I21 to one of the execution sections 30₁-30ₙ₋₁ (FIG. 2). Furthermore, the execution sections 30₁-30ₙ₋₁ retire the instructions I12-I14.

Still referring to FIG. 7, the DA stage 52, while executing the store instruction I15, determines that the memory location at M1, to which a data value D1 is to be written in response to the instruction I15, has already been read by the load instruction I16, which comes after I15 in the program order. In response to this determination, the DA stage 52 sets a load-mis-speculation flag, and associates this flag with the load instruction I16. The DA stage 52 may set this flag in the slot of LQ 44 where I16 is located, in the slot of the ROB 46 where I16 is located, in both of these slots, or in some other location. But for example purposes, it is assumed that the DA stage 52 sets this flag in the slot of the LQ 44 where I16 is located.

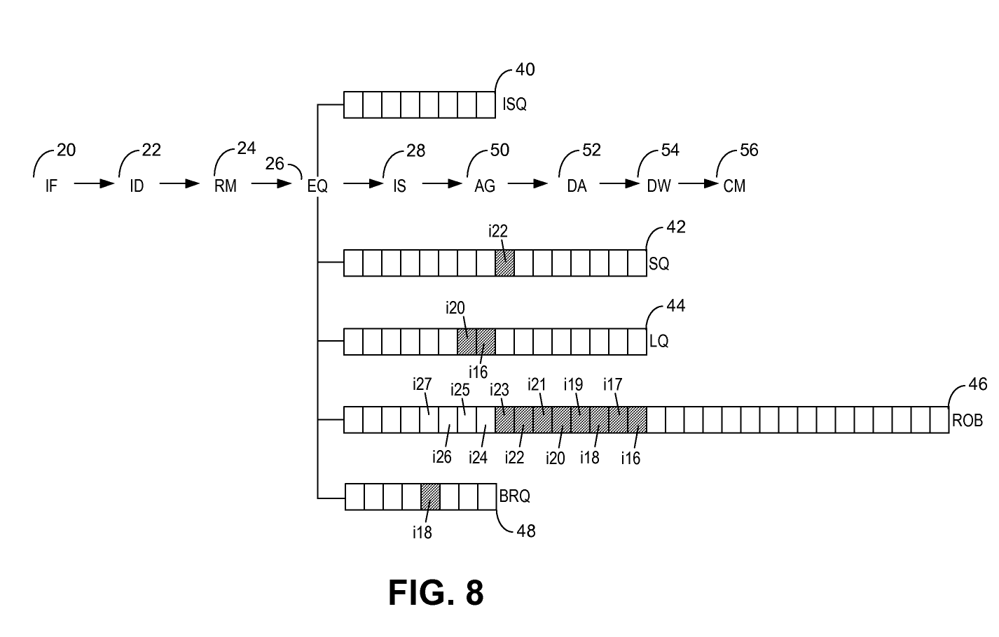

Referring to FIG. 8, in a next operating state one or more cycles after the operating state represented in FIG. 7, the CM stage 56 retires the store instruction I15, and attempts to retire the load instruction I16. But because a load-mis-speculation flag is set for the load instruction I16, the CM stage 56 cannot retire I16. Instead, the CM stage 56 causes the processor 8 to flush the ISQ 40, the IS stage 28, the AG stage 50, the DA stage 52, the DW stage 54, and the CM stage 56, and the stages of the other execution sections 30₁-30ₙ₋₁ (FIG. 2). Furthermore, the CM stage 56 causes the processor 8 to stall, but not flush, the IF stage 20, the ID stage 22, the RM stage 24, and any other stages of the pipeline 10 before the EQ stage 26. The processor 8 may perform the flush and stall in any suitable manner. By flushing only the IS stage 28, the ISQ 40, and the stages of the execution sections 30₁-30ₙ, the processor 8 may reduce the flush-induced increase in the program processing time, and may reduce the flush-induced expended energy compared to a processor that flushes the entire pipeline 10. For example, the partial pipeline flush may reduce processing time and energy consumption at least because the stages 20, 22, and 24 do not need to be repopulated after the flush.

Still referring to FIG. 8, after the partial flush of the pipeline 10, at least the instructions I16-I27 are in the ROB 46.

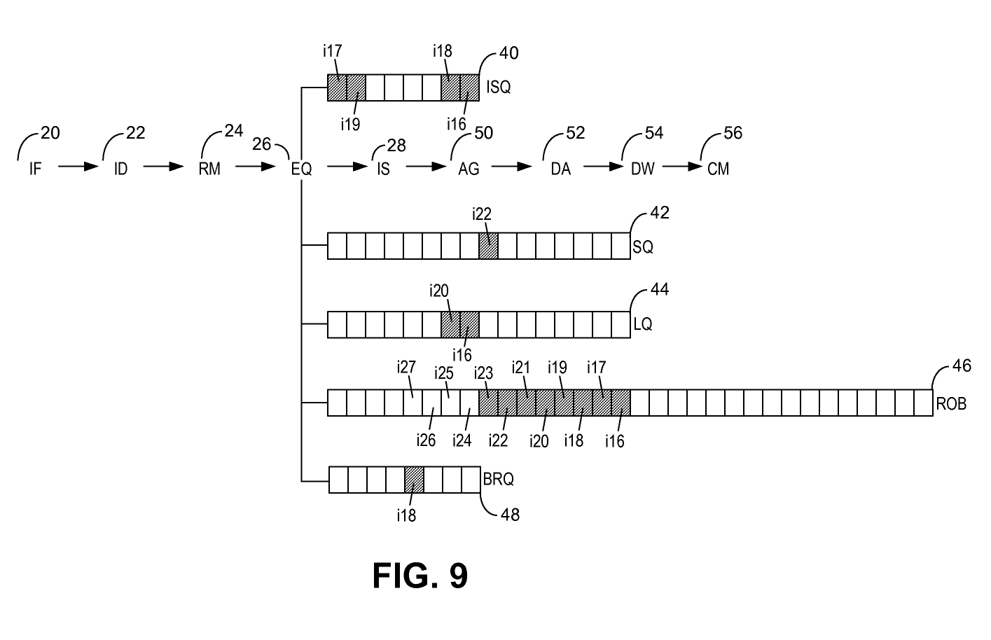

Referring to FIG. 9, in a next operating state a cycle after the operating state represented in FIG. 8, the EQ stage 26 loads the first four instructions in the program order, I16-I19 in this example, from the ROB 46 to the ISQ 40, and maintains the stages 20, 22, and 24 stalled. Alternatively, if the EQ stage 26 is operable to load more than four instructions into the ISQ 40 at one time, then the EQ stage may simultaneously load into the ISQ all of the instructions I16-I27 that are in the ROB 46 immediately after the flush.

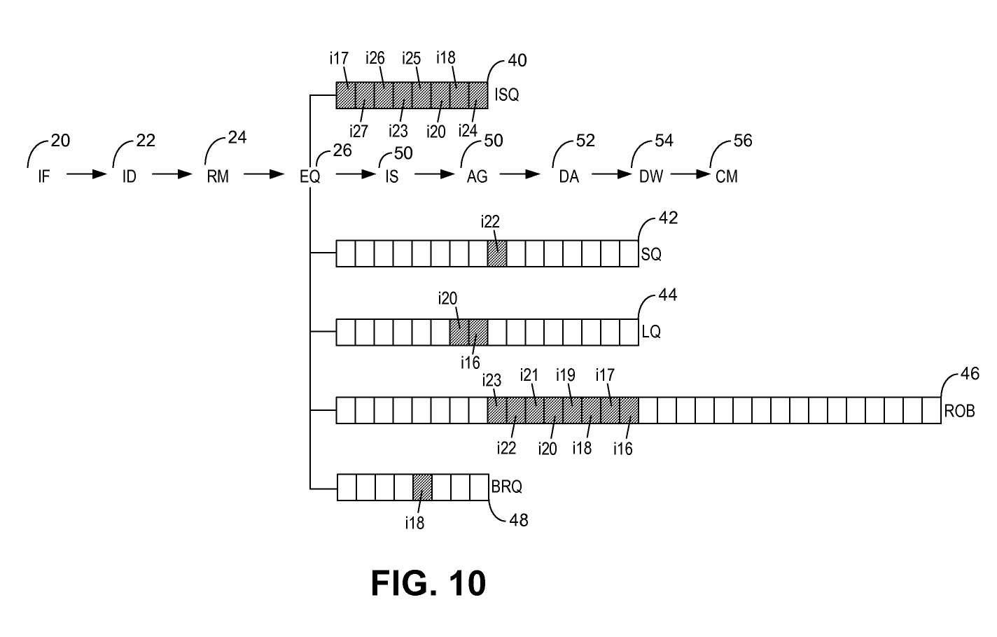

Referring to FIG. 10, in the next operating state a cycle after the operating state represented in FIG. 9, the IS stage 28 issues the instruction I16 to the AG 50, and issues, for example, the instructions I19, I21, and I22 to respective ones of the other execution sections 30₁-30ₙ₋₁. Furthermore, the EQ stage 26 loads the remaining instructions (I24-I27 in this example) into the ISQ 40, and the processor un-stalls the stages 20, 22, and 24 so that in subsequent operating states, the RM stage 24 may once again provide additional instructions to the EQ stage 26. Because the stages 20, 22, and 24 were not flushed, the latency associated with restarting the normal operation of the pipeline 10 is reduced as compared to the latency associated with a fully flushed pipeline. As alluded to above, this reduction in latency may reduce the processing time lost due to the flush, and may reduce the energy expended due to the flush.

In the next operating states one and two cycles after the operating state represented in FIG. 10, the DA and DW stages 52 and 54 respectively execute the read and write-back portions of the load instruction I16. But because the store instruction I15 was already executed before the flush, the load instruction reads the correct data value from the memory location at the address M1 such that subsequent results generated from this loaded data value are correct.

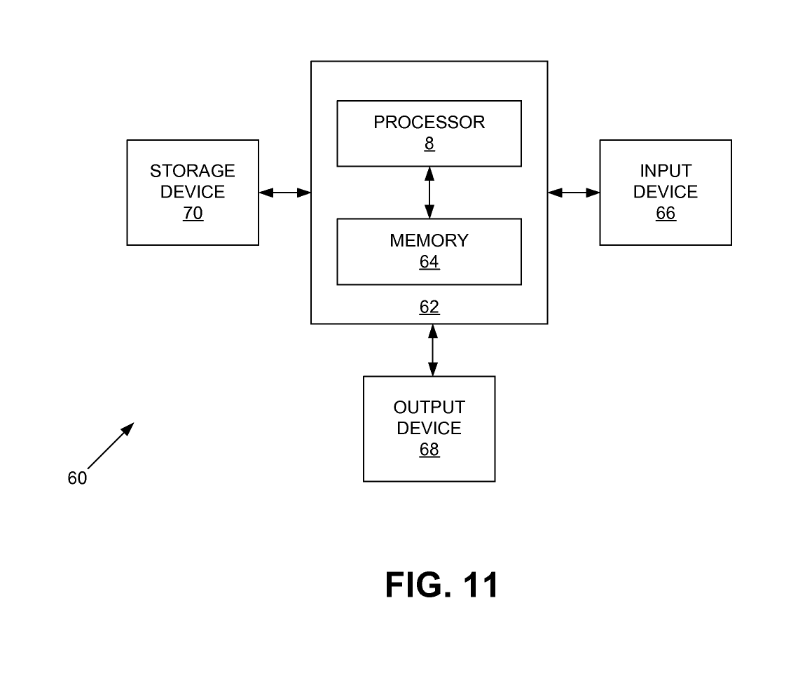

FIG. 11 is a block diagram of an embodiment of a computer system 60, which incorporates an embodiment of the superscalar processor 8 of FIG. 1 that implements an embodiment of a partial pipeline flush as described above in conjunction with FIGS. 5-10. Although the system 60 is described as a computer system, it may be any system for which an embodiment of a partial-pipeline-flush processor is suited.

The system 60 includes computing circuitry 62, which, in addition to the processor 8, includes a memory 64 coupled to the processor, and the system also includes an input device 66, an output device 68, and a data-storage device 70.

The processor 8 may process data in response to program instructions stored in the memory 64, and may also store data to the memory and load data from the memory, or may load data from one location of the memory to another location of the memory. In addition, the processor 8 may perform any functions that a processor or controller may perform.

The memory 64 may be on the same die as, or on a different die relative to, the processor 8, and may store program instructions or data as discussed above. Where disposed on the same die as the processor 8, the memory 64 may be a cache memory. Furthermore, the memory 64 may be a non-volatile memory, a volatile memory, or may include both non-volatile and volatile memory cells.

The input device (e.g., keyboard, mouse) 66 allows, e.g., a human operator, to provide data, programming, and commands to the computing circuitry 62.

The output device (e.g., display, printer, speaker) 68 allows the computing circuitry 62 to provide data in a form perceivable by e.g., a human operator.

And the data-storage device (e.g., flash drive, hard disk drive, RAM, optical drive) 70 allows for the non-volatile storage of, e.g., programs and data.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

What is claimed is:

1. An instruction pipeline, comprising:
a first section operable to provide first and second ordered instructions; and
a second section operable:
in response to the second instruction, to read first data from a data-storage location,
in response to the first instruction, to write second data to the data-storage location after reading the first data, and
in response to the writing the second data after reading the first data, to cause the flushing of some, but not all, of the pipeline.

2. The instruction pipeline of claim 1 wherein the first section is operable to provide the first and second ordered instructions in an order in which the first and second instructions are positioned in a software program.

3. The instruction pipeline of claim 1 wherein the first section comprises an instruction-fetch stage.

4. The instruction pipeline of claim 1 wherein the first section comprises an instruction-decode stage.

5. The instruction pipeline of claim 1 wherein the first section comprises a register-mapping stage.

6. The instruction pipeline of claim 1 wherein the second section comprises a data-access stage.

7. The instruction pipeline of claim 1 wherein the second section is operable:
to associate a flag with the second instruction in response to writing the second data to the data-storage location after reading the first data from the data-storage location; and
to cause the flushing in response to the flag.

8. The instruction pipeline of claim 1, further comprising:
a third section including first and second instruction queues operable to receive the first and second instructions from the first section; and
wherein the second section is operable:
to receive the first and second instructions from one of the first and second queues; and
in response to the second section writing the second data after reading the first data, to flush the one of the first and second queues and to load the second instruction from the other of the first and second queues into the one of the first and second queues.

9. The instruction pipeline of claim 1, further comprising:
a third section including:
first and second instruction queues operable to receive the first and second instructions from the first section; and
a third instruction queue operable to receive the second instruction from the first section; and
wherein the second section is operable:
to receive the first and second instructions from one of the first and second queues, and is operable to associate a flag with the second instruction in the third instruction queue in response to writing the second data after reading the first data; and
in response to the flag, to flush the one of the first and second queues and to load the second instruction from the other of the first and second queues into the one of the first and second queues.

10. The instruction pipeline of claim 1, further comprising:
wherein the first instruction comprises a store instruction;
wherein the second instruction comprises a load instruction;
a third section including:
a reorder buffer and an instruction-issue queue operable to receive the store and load instructions from the first section; and
a load-instruction queue operable to receive the load instruction from the first section; and
wherein the second section comprises:
a data-access stage that is operable to receive the store and load instructions from the instruction-issue queue, to execute the load instruction before executing the store instruction, and to associate a flag with the load instruction in the load-instruction queue in response to executing the store instruction after executing the load instruction; and
an instruction-commit stage that is operable, in response to the flag, to cause the flushing of the instruction-issue queue and reloading of the load instruction into the instruction-issue queue from the reorder buffer.

11. The instruction pipeline of claim 1, further comprising:
wherein the first instruction comprises a store instruction;
wherein the second instruction comprises a load instruction;
a third stage that includes:
a reorder buffer and an instruction-issue queue operable to receive the store and load instructions and a third ordered instruction from the first section; and
a load-instruction queue operable to receive the load instruction from the first section; and
wherein the second section comprises:
a data-access stage that is operable to receive the store and load instructions from the instruction-issue queue, to execute the load instruction before executing the store instruction, and to associate a flag with the load instruction in the load-instruction queue in response to executing the store instruction after executing the load instruction; and
an instruction-commit stage that is operable, in response to the flag, to cause the flushing of the instruction-issue queue and reloading of the load instruction and the third instruction into the instruction-issue queue from the reorder buffer.

12. The instruction pipeline of claim 1 wherein the data-storage location comprises a cache location.

13. The instruction pipeline of claim 1 wherein the second section is operable to cause the flushing of the second section.

14. The instruction pipeline of claim 1 wherein the second section is operable, in response to the second section writing the second data after reading the first data, to cause the flushing of a pipeline section other than the first section.

15. A processor, comprising:
instruction pipeline, comprising:
a first section operable to provide first and second ordered instructions; and
a second section operable:
in response to the second instruction, to read first data from a data-storage location, and operable, in response to the first instruction, to write second data to the data-storage location after reading the first data; and
in response to writing the second data after reading the first data, to cause the flushing of some, but not all, of the pipeline.

16. The processor of claim 15, further comprising a memory coupled to the pipeline and operable to store the first and second instructions.

17. A system, comprising:
a processor, comprising:
an instruction pipeline, comprising:
a first section operable to provide first and second ordered instructions; and
a second section operable:
in response to the second instruction, to read first data from a data-storage location, and operable, in response to the first instruction, to write second data to the data-storage location after reading the first data; and
in response to writing the second data after reading the first data, to cause the flushing of some, but not all, of the pipeline; and
an integrated circuit coupled to the processor.

18. The system of claim 17 wherein the processor and integrated circuit are disposed on a same die.

19. The system of claim 17 wherein the processor and integrated circuit are disposed on respective dies.

20. The system of claim 17 wherein the integrated circuit comprises a memory.

21. The system of claim 17 wherein the processor is operable to control the integrated circuit.

22. A method, comprising:
determining that a processing pipeline read a memory location in response to a second instruction before writing the memory location in response to a first instruction that the processing pipeline fetched before the second instruction; and
flushing at least one portion, but fewer than all portions, of the processing pipeline in response to the determining.

23. The method of claim 22 wherein determining that the processing pipeline read the memory location comprises making a determination that the processing pipeline read the memory location before the processing pipeline writes the memory location in response to the first instruction.

24. The method of claim 22 wherein determining that the processing pipeline read the memory location comprises making a determination that the processing pipeline read the memory location while the processing pipeline is writing the memory location in response to the first instruction.

25. The method of claim 22 wherein determining that the processing pipeline read the memory location comprises making a determination that the processing pipeline read the memory location after the processing pipeline writes the memory location in response to the first instruction.

26. The method of claim 22 wherein determining that the processing pipeline read the memory location comprises making a determination that the processing pipeline read the memory location before the processing pipeline executes the first instruction.

27. The method of claim 22 wherein determining that the processing pipeline read the memory location comprises making a determination that the processing pipeline read the memory location while the processing pipeline is executing the first instruction.

28. The method of claim 22 wherein determining that the processing pipeline read the memory location comprises making a determination that the processing pipeline read the memory location after the processing pipeline executes the first instruction.

29. The method of claim 22 wherein determining that the processing pipeline read the memory location comprises making a determination that the processing pipeline read the memory location in response to the processing pipeline executing the first instruction.

30. The method of claim 22 wherein flushing at least one portion of the pipeline comprises flushing at least one portion that is after an enter queue of the pipeline.

31. The method of claim 22 wherein flushing at least one portion of the pipeline comprises flushing no portion that is before an enter queue of the pipeline.

32. The method of claim 22, further comprising repopulating an issue queue of the pipeline from a reorder buffer of the pipeline in response to the flushing.

33. The method of claim 22, further comprising repopulating an issue queue of the pipeline starting with the second instruction in response to the flushing.

34. The method of claim 22, further comprising stalling an unflushed portion of the pipeline in response to the flushing.

35. The method of claim 22, further comprising:
wherein flushing comprises flushing no portion of the pipeline that is located before an issue queue of the pipeline;
stalling a portion of the pipeline that is located before the issue queue until all of the instructions in a reorder buffer of the pipeline have been loaded into the issue queue.

36. The method of claim 22, further comprising:
wherein flushing comprises flushing no portions of the pipeline that are located before an issue queue of the pipeline;
stalling a section of the pipeline that is located before the issue queue until all of the instructions in a reorder buffer of the pipeline have been loaded into the issue queue and until the issue queue has an open slot.

37. The method of claim 22, further comprising:
flagging the second instruction in response to the determining; and
wherein flushing the at least one portion of the pipeline comprises flushing the at least one portion in response to the flagging.
